(19) United States
(12) Patent Application Publication
(10) Pub. No.: US 2026/0166685 A1
(43) Pub. Date: Jun. 18, 2026

(54) RATCHET WRENCH

(71) Applicant: YUNG-TSUNG CHANG, Taichung City (TW)

(72) Inventor: YUNG-TSUNG CHANG, Taichung City (TW)

(21) Appl. No.: 18/982,203

(22) Filed: Dec. 16, 2024

(51) Int. Cl. B25B 13/48; B25B 13/46; B25B 23/00

(52) U.S. Cl. CPC B25B 13/481; B25B 13/462; B25B 23/0028

(57) ABSTRACT

A ratchet wrench is provided, wherein the ratchet wrench includes: a main body; a first working head including a first base disposed on an end of the main body, and a first ratchet member rotatably disposed on at the first base and rotatable about a first rotation axis; an insertion rod detachably inserted in the first ratchet member and rotatable with the first ratchet member; two adapters detachably assembled to opposite sides of the insertion rod protrusive beyond the first working head, respectively, wherein when the insertion rod is not inserted in the first ratchet member, each of the two adapters is capable being inserted in the first ratchet member in a direction of the first rotation axis and rotatable with the first ratchet member; and a drive head disposed on an other end of the main body and configured to engage with a driven member.

### BACKGROUND OF THE INVENTION

### Field of the Invention

The present invention relates to a driving tool, particularly to a ratchet wrench.

### Description of the Prior Art

Ratchet tools allow users to rotate fasteners such as screws, bolts, nuts, etc., in narrow spaces by moving their hands back and forth. The ratchet tool, with a ratchet mechanism as its core component, can rotate fasteners in a preset driving direction while not rotating them in the opposite direction. This significantly reduces the required operational clearance and eliminates frequent repositioning of the tool to perform the rotation, thereby effectively improving work efficiency.

However, conventional ratchet tools commonly include a single head with a ratchet mechanism fixed at an end of the handle. This design limits flexibility and adaptability, offering less variability in operation and making it unsuitable for diverse environments.

The present invention is, therefore, arisen to obviate or at least mitigate the above-mentioned disadvantages.

### SUMMARY OF THE INVENTION

The main object of the present invention is to provide a ratchet wrench which can be used in an L-shaped configuration or T-shaped configuration so that it enables operation within narrow spaces and provides various usage configurations to choose from.

To achieve the above and other objects, a ratchet wrench is provided, wherein the ratchet wrench includes: a main body; a first working head including a first base and a first ratchet member, the first base being disposed on an end of the main body, the first ratchet member being rotatably disposed on at the first base and rotatable about a first rotation axis; an insertion rod detachably inserted in the first ratchet member in a direction of the first rotation axis and rotatable with the first ratchet member; two adapters detachably assembled to opposite sides of the insertion rod protrusive beyond the first working head, respectively, wherein when the insertion rod is not inserted in the first ratchet member, each of the two adapters is capable being inserted in the first ratchet member in the direction of the first rotation axis and rotatable with the first ratchet member; and a drive head disposed on an other end of the main body and configured to be assembled with a driven member.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an exemplary embodiment of the present invention;

FIG. 2 is an exploded view of FIG. 1;

FIG. 3 is a schematic view showing a blocking portion of an adapter and a first ratchet member blocked with each other according to an exemplary embodiment of the present invention;

FIG. 4 is a schematic view showing an adapter inserted in the first ratchet member according to an exemplary embodiment of the present invention

FIG. 5 is a perspective view showing a main body, a first working head and a second working head of an exemplary embodiment of the present invention;

FIG. 6 is an exploded view of FIG. 5;

FIG. 7 is a schematic view showing the first working head swinging relative to the main body according to the exemplary embodiment of the present invention;

FIG. 8 is a schematic view showing the second working head swinging relative to the main body according to the exemplary embodiment of the present invention; and

FIGS. 9 and 10 are schematic view showing operation states of the exemplary embodiment of the present invention.

### DETAILED DESCRIPTION OF THE PREFERRED EMBODIMENTS

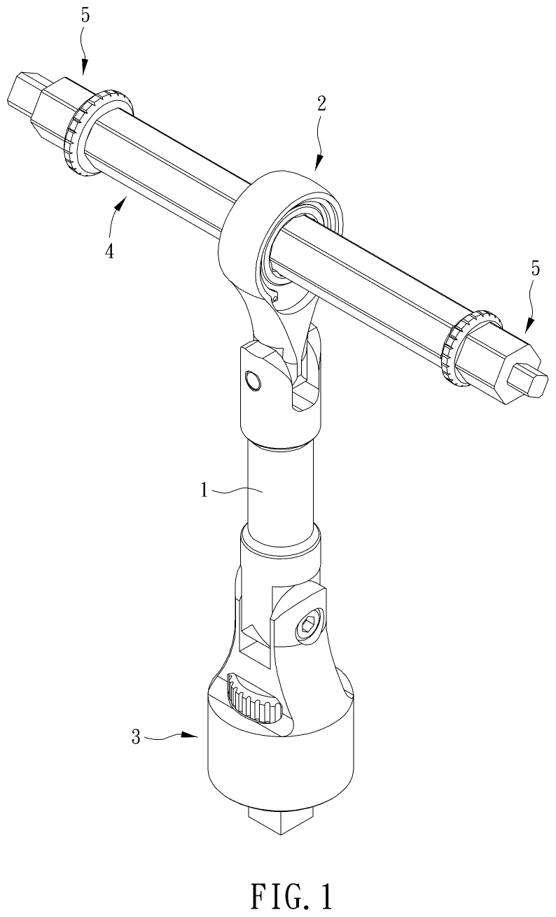

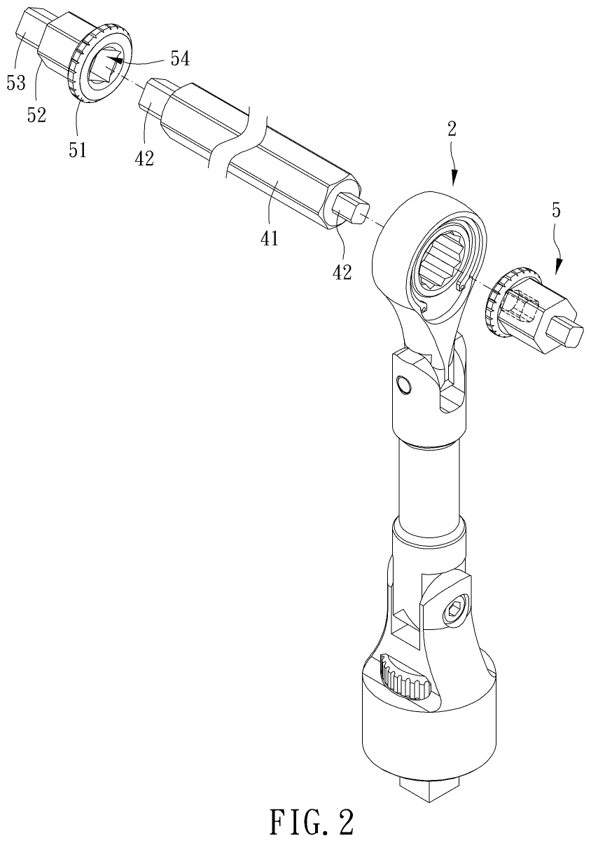

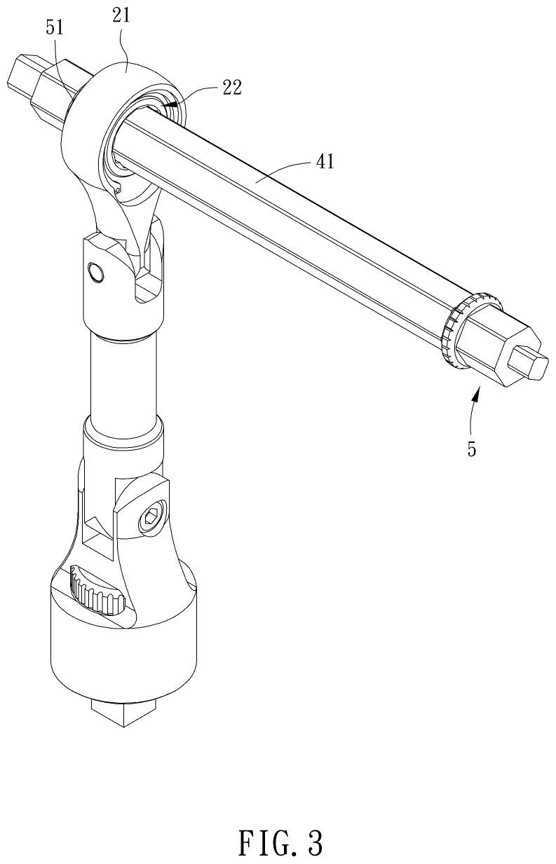

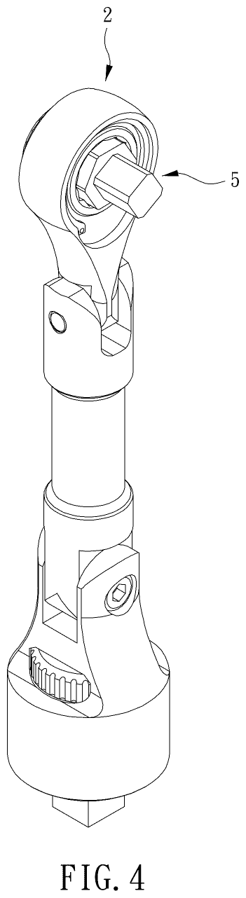

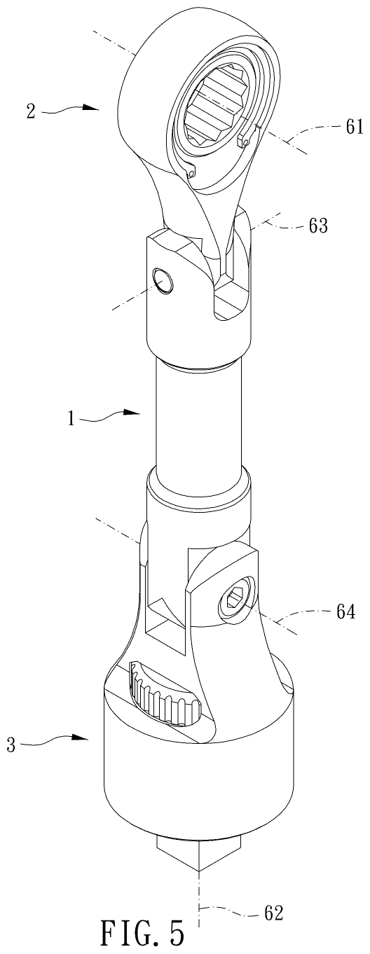

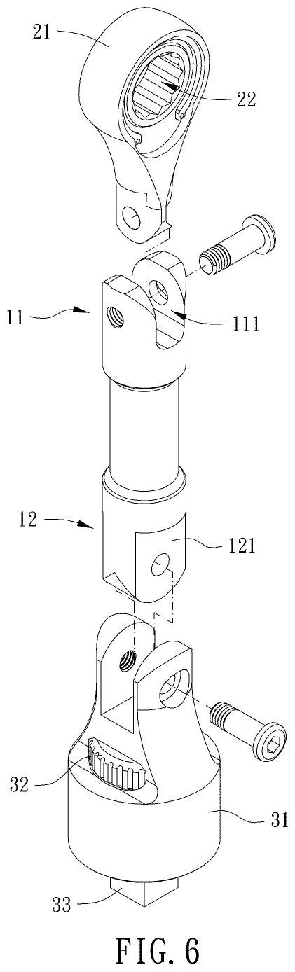

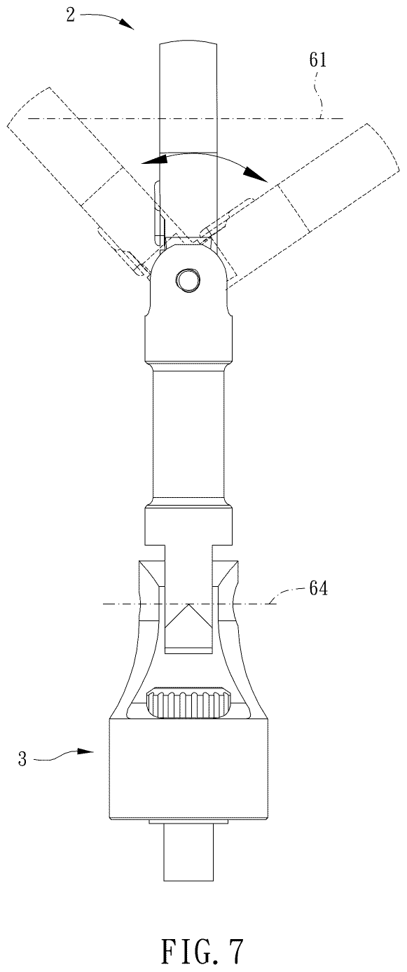

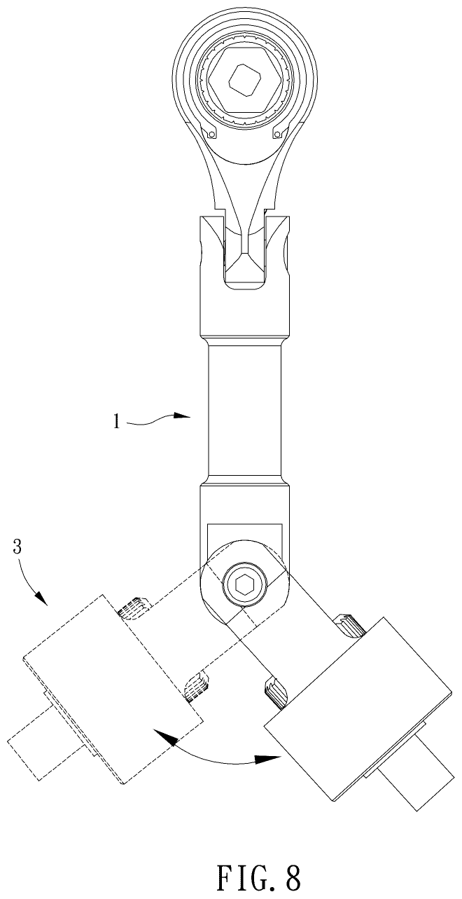

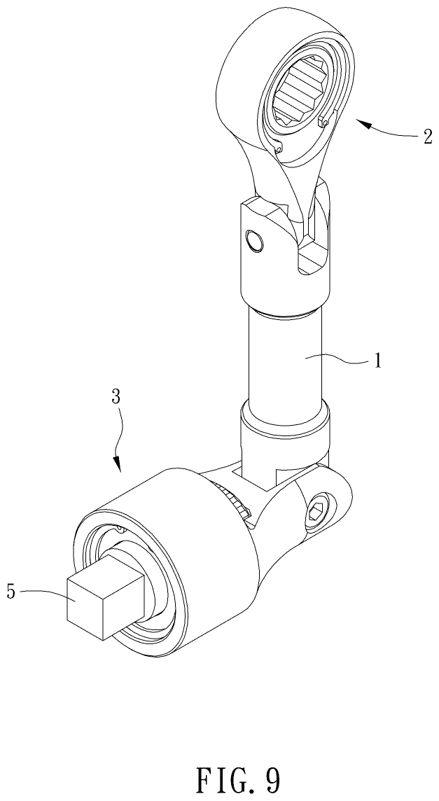

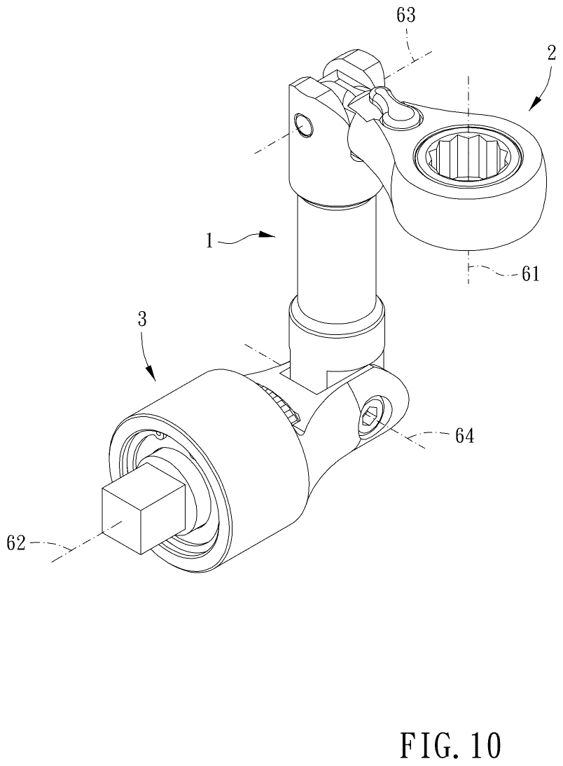

Please refer to FIGS. 1 to 10 for an exemplary embodiment of the present invention. A ratchet wrench of the present invention includes a main body 1, a first working head 2, an insertion rod 4, two adapters 5, and a drive head 33.

The first working head 2 includes a first base 21 and a first ratchet member 22. The first base 21 is disposed on an end of the main body 1, and the first ratchet member 22 is rotatably disposed on the first base 21 and rotatable about a first rotation axis 61. The insertion rod 4 is detachably inserted in the first ratchet member 22 in a direction of the first rotation axis 61 and is rotatable with the first ratchet member 22. The two adapters 5 are detachably assembled to opposite sides of the insertion rod 4 protruding beyond the first working head 2, respectively. Each of the two adapters 5 is configured to be assembled with a driven member. When the insertion rod 4 is not inserted in the first ratchet member 22, each of the two adapters 5 is capable being inserted in the first ratchet member 22 in the direction of the first rotation axis 61 and is rotatable with the first ratchet member 22, providing more various operating configurations. The drive head 33 is disposed on an other end of the main body 1 to be assembled with a driven member.

When the insertion rod 4 is inserted in the first ratchet member 22, two exemplary usage configurations can be provided to the user, as follows. Configuration 1: Similar to using an L-shaped rod, the insertion rod 4 allows the adapter 5 to extend deep into a space to engage with a driven member so that the user can hold the main body 1 to rotate the insertion rod 4 via the first ratchet member 22. Configuration 2: Similar to using a T-shaped rod, the drive head 33 engages with a driven member, and the user holds the insertion rod 4 to drive the main body 1 to rotate.

Specifically, each of the two adapters 5 includes a blocking portion 51, a body portion 52, and a head portion 53. The blocking portion 51 extends transversely from a side of the body portion 52. The blocking portion 51 and the first ratchet member 22 are blockable with each other in the direction of the first rotation axis 61 to prevent detachment. The body portion 52 is insertable in the first ratchet member 22, and the head portion 53 extends axially from the body portion 52 in a direction opposite the blocking portion 51 to engage with a driven member. In the direction of the first rotation axis 61, the body portion 52 has a length greater than a length of the head portion 53 to ensure sufficient structural strength for engagement with the first ratchet member 22.

Preferably, the head portions 53 of the two adapters 5 have different dimensions, and the drive head 33 has a dimension different from a dimension of the head portions 53 of each of the two adapters 5. This allows users to choose from various shapes and sizes based on their needs.

Specifically, each of the two adapters 5 further includes an insertion hole 54. The insertion hole 54 extends from a side of the body portion 52 remote from the head portion 53 toward the head portion 53. The insertion rod 4 includes a rod body 41 and two connectors 42. The two connectors 42 extend axially from opposite ends of the rod body 41 and are each detachably inserted in the insertion hole 54. This detachable design allows users to quickly assemble or disassemble the insertion rod 4 and the adapter 5.

Preferably, each connector 42 has a dimension matching with a dimension of the head portion 53 of an associated one of the two adapters 5. This facilitates quick recognition during assembly and allows each connector 42 to directly engage with a driven member.

Preferably cross-sections of the insertion rod 4 and the body portion 52 are polygonal, enabling better structural compatibility with various tools (e.g., wrenches) for cooperative rotation.

In this embodiment, the first base 21 is swingably disposed on a first assembling portion 11 of the main body 1 and swingable about a first pivot axis 63, wherein the first rotation axis 61 and the first pivot axis 63 do not intersect each other. Furthermore, the ratchet wrench further includes a second working head 3. The second working head 3 includes a second base 31, a second ratchet member 32, and the drive head 33. The second base 31 is swingably disposed on a second assembling portion 12 of the main body 1 and swingable about a second pivot axis 64. The second pivot axis 64 is transverse to the first pivot axis 63. The second ratchet member 32 is rotatably disposed on the second base 31 and rotatable about a second rotation axis 62, wherein the second rotation axis 62 and the second pivot axis 64 intersect each other. The drive head 33 is disposed on the second ratchet member 32 and is rotatable about the second rotation axis 62 and rotatable with the second ratchet member 32.

The swing directions of the first working head 2 and the second working head 3 are different, allowing various swing angles for different applications. Additionally, since the rotational directions of the first ratchet member 22 and the second ratchet member 32 are differently configured, it provides various combinations for usage, enabling effective adaptation to various environments.

Preferably, one of the first assembling portion 11 and the second assembling portion 12 includes an assembling space 111, and an other of the first assembling portion 11 and the second assembling portion 12 includes two flat surfaces 121 on an outer surface thereof. One of the first base 21 and the second base 31 is swingably inserted in the assembling space 111, and an other of the first base 21 and the second base 31 is swingably disposed between the two flat surfaces 121. The first assembling portion 11 and the second assembling portion 12 are respectively assembled with the first base 21 and the second base 31 by a male-female connection manner, which not only facilitates quick differentiation during assembly but also ensures a certain structural strength for the main body 1.

When the first rotation axis 61 and the second pivot axis 64 are parallel to each other, the first working head 2 does not extend beyond the second working head 3 in the extension direction of the second pivot axis 64. Utilizing structural differences in thickness and size offers users a greater variety of application options.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A ratchet wrench including:
a main body;
a first working head including a first base and a first ratchet member, the first base being disposed on an end of the main body, the first ratchet member being rotatably disposed on at the first base and rotatable about a first rotation axis;
an insertion rod detachably inserted in the first ratchet member in a direction of the first rotation axis and rotatable with the first ratchet member;
two adapters detachably assembled to opposite sides of the insertion rod protrusive beyond the first working head, respectively, wherein when the insertion rod is not inserted in the first ratchet member, each of the two adapters is capable being inserted in the first ratchet member in the direction of the first rotation axis and rotatable with the first ratchet member; and
a drive head disposed on an other end of the main body and configured to be assembled with a driven member.

2. The ratchet wrench of claim 1, wherein each of the two adapters includes a blocking portion, a body portion and a head portion, the blocking portion extends transversely from a side of the body portion, the blocking portion and the first ratchet member are blockable with each other in the direction of the first rotation axis, the body portion is insertable in the first ratchet member, and the head portion axially extends from the body portion in the direction opposite the blocking portion.

3. The ratchet wrench of claim 2, wherein cross-sections of the insertion rod and the body portion are polygonal.

4. The ratchet wrench of claim 2, wherein each of the two adapters further includes an insertion hole, the insertion hole extends from a side of the body portion remote from the head portion toward the head portion, the insertion rod includes a body portion and two connectors, and the two connectors extend axially from opposite ends of the body portion and are each detachably inserted in the insertion hole.

5. The ratchet wrench of claim 2, wherein the head portions of the two adapters have different dimensions.

6. The ratchet wrench of claim 1, wherein the first base is swingably disposed on a first assembling portion of the main body and swingable about a first pivot axis, and the first rotation axis and the first pivot axis do not intersect each other.

7. The ratchet wrench of claim 6, further including a second working head, wherein the second working head includes a second base, a second ratchet member and the drive head, the second base is swingably disposed on a second assembling portion of the main body and swingable about a second pivot axis, the second pivot axis is transverse to the first pivot axis, the second ratchet member is rotatably disposed on the second base and rotatable about a second rotation axis, the second rotation axis and the second pivot axis intersect each other, and the drive head is disposed on the second ratchet member and is rotatable about the second rotation axis and rotatable with the second ratchet member.

8. The ratchet wrench of claim 7, wherein one of the first assembling portion and the second assembling portion includes an assembling space, an other of the first assembling portion and the second assembling portion includes two flat surfaces on an outer surface thereof, one of the first base and the second base is swingably inserted in the assembling space, and an other of the first base and the second base is swingably disposed between the two flat surfaces.

9. The ratchet wrench of claim 7, wherein when the first rotation axis and the second pivot axis are parallel to each other, the first working head is not protrusive beyond the second working head in an extension direction of the second pivot axis.

10. The ratchet wrench of claim 4, wherein cross-sections of the insertion rod and the body portion are polygonal; the head portions of the two adapters have different dimensions; the first base is swingably disposed on a first assembling portion of the main body and swingable about a first pivot axis, and the first rotation axis and the first pivot axis do not intersect each other; the ratchet wrench further includes a second working head, wherein the second working head includes a second base, a second ratchet member and the drive head, the second base is swingably disposed on a second assembling portion of the main body and swingable about a second pivot axis, the second pivot axis is transverse to the first pivot axis, the second ratchet member is rotatably disposed on the second base and rotatable about a second rotation axis, the second rotation axis and the second pivot axis intersect each other, and the drive head is disposed on the second ratchet member and is rotatable about the second rotation axis and rotatable with the second ratchet member; one of the first assembling portion and the second assembling portion includes an assembling space, an other of the first assembling portion and the second assembling portion includes two flat surfaces on an outer surface thereof, one of the first base and the second base is swingably inserted in the assembling space, and an other of the first base and the second base is swingably disposed between the two flat surfaces; when the first rotation axis and the second pivot axis are parallel to each other, the first working head is not protrusive beyond the second working head in an extension direction of the second pivot axis; in the direction of the first rotation axis, the body portion has a length greater than a length of the head portion; each of the two connectors has a dimension matching with a dimension of the head portion of an associated one of the two adapters; and the drive head has a dimension different from a dimension of the head portion of each of the two adapters.
